(19) United States
(12) Patent Application Publication
(10) Pub. No.: US 2024/0424843 A1
(43) Pub. Date: Dec. 26, 2024

(54) ADJUSTABLE HITCH ASSEMBLY WITH LOCKABLE COUPLER

(71) Applicant: Horizon Global Americas Inc., Cleveland, OH (US)

(72) Inventors: Theodore Joseph Siegel, Cleveland, OH (US); Eric Michael Yukich, Cleveland, OH (US)

(73) Assignee: Horizon Global Americas Inc., Cleveland, OH (US)

(21) Appl. No.: 18/671,373

(22) Filed: May 22, 2024

Related U.S. Application Data
(60) Provisional application No. 63/468,072, filed on May 22, 2023.

(51) Int. Cl. B60D 1/46; B60D 1/52; B60D 1/58

(52) U.S. Cl. CPC B60D 1/46; B60D 1/52; B60D 1/58

(57) ABSTRACT

Disclosed is an adjustable hitch assembly for coupling a towed vehicle to a load to be towed. The adjustable hitch assembly includes an elongated housing having an elongated interior. A threaded shaft extends within the interior of the housing. A carriage member includes a base, a coupling member and an attachment member, wherein the base is at least partially within the elongated housing and threadably received on said shaft for translation within the housing, the coupling member is attached to the base, the attachment member is selectively secured to the coupling member. A locking member may selectively attach or secure the coupling member to the attachment member. The locking member may be selectively lockable to prevent or allow said locking member from being removed from the coupling member and the attachment member.

### CLAIM OF PRIORITY TO PRIOR APPLICATION

This application claims the benefit of the filing date of U.S. Provisional Application, Ser. No. 63/468,072, filed on May 22, 2023, entitled “Adjustable Hitch Assembly with Lockable Coupler”. By this reference the entire disclosure, including the claims and drawings, of U.S. Provisional Application, Ser. No. 63/468,072 is hereby incorporated into the present disclosure as though now set forth in its entirety.

### FIELD OF INVENTION

The disclosure relates to an adjustable hitch assembly with a lockable coupler.

### BACKGROUND

Many people have a need to haul a load behind a vehicle. Typically, a towed vehicle is coupled to a towing vehicle with a hitch assembly. Many methods and devices have been developed for connecting the towed vehicle to the towing vehicle. Such devices include receiver hitches (e.g. pin hitches and ball hitches), gooseneck hitches, fifth wheel hitches, and other types of commonly known hitches. Typical receiving hitches often include a receiving member connected to the towing vehicle, a ball member connected to the receiving member, and a coupler member connected to the towed vehicle and engaged with the ball member.

Hitch assemblies may include various coupling members such as a ball hitch that couples to a ball socket. A problem occurs when the ball hitch is higher or lower than the ball socket. For instance, a small trailer might sit low to the ground. When towed behind a taller vehicle, the trailer may ride at an angle because the ball socket may have to be tipped upwards to reach the higher ball hitch. U.S. Pat. No. 8,979,112, which is incorporated by reference in its entirety, is an example of an adjustable hitch assembly having an adjustable height wherein the adjustability of the height is determined by the location and arrangement of a plurality of openings along the surface of a shank member (see FIG. 1A). Further, U.S. Pat. No. 6,824,156, identifies an adjustable hitch member having a telescoping screw within a housing that provides for adjustability along the length of the screw (see FIG. 1B).

However, adjustable assemblies used to couple together loads such as between a towed and towing vehicle are generally left unsecured and include bulky parts that may be difficult for a user to easily move or adjust. Therefore, there is a need for providing an assembly that allows for quick adjustability while providing structural stability. There is also a need for an assembly that may provide a secured way for coupling a hitch member to the housing.

### SUMMARY

In one embodiment, disclosed is an adjustable hitch assembly for coupling a towed vehicle to a load to be towed. The adjustable hitch assembly includes an elongated housing having an elongated interior. A threaded shaft extends within the interior of the housing. A carriage member includes a base, a coupling member and an attachment member, wherein the base is at least partially within the elongated housing and threadably received on said shaft for translation within the housing, the coupling member is attached to the base, the attachment member is selectively secured to the coupling member. A locking member may selectively attach or secure the coupling member to the attachment member. Rotation of the threaded shaft may imparts translation of the carriage member relative to the elongated housing. The locking member may be selectively lockable to prevent or allow said locking member from being removed from the coupling member and the attachment member.

The locking member may include at least one pin that extends from a lock base. However, the locking member may include a plurality of pins such as a first pin and a second pin that extend from a common side of the lock base. The pins may be generally parallel to one another as positioned along the lock base. A locking mechanism may be attached to the lock base. The locking mechanism may be a tubular lock device that corresponds with a cylinder shape key. In one embodiment, the locking mechanism may include a keyway and a plug with a protrusion wherein the plug and protrusion are configured to be selectively extended through the coupling member and be received within the attachment member. The protrusion may selectively toggled against an interior portion of the attachment member to lock or unlock the locking member.

The attachment member may include a various towing accessories that extend therefrom. The towing accessory may includes at least one of a hitch ball, a hitch ball with an acircular base, a step, a shackle, and a pintle plate.

### BRIEF DESCRIPTION OF THE DRAWINGS

Operation of the invention may be better understood by reference to the detailed description taken in connection with the following illustrations, wherein:

FIG. 1A is a perspective view of embodiments of a prior art adjustable hitch assembly;

FIG. 1B is a perspective view of embodiments of a prior art adjustable hitch assembly;

FIG. 2 is a perspective view of embodiments of an adjustable hitch assembly and coupler lock member in accordance with the present disclosure;

FIG. 3A is an exploded perspective view of the adjustable hitch assembly in accordance with FIG. 2;

FIG. 3B is an enlarged exploded perspective view of portions of FIG. 3A;

FIG. 4A is a perspective view of a pin assembly in accordance with the present disclosure;

FIG. 4B is a side view of a pin assembly of FIG. 4A in accordance with the present disclosure;

FIG. 5 is a side perspective view of an attachment member of the adjustable hitch assembly in accordance with the present disclosure;

FIG. 6 is a perspective view of an embodiment of the adjustable hitch assembly of in accordance with the present disclosure;

FIG. 7 is a perspective view of an embodiment of the adjustable hitch assembly in accordance with the present disclosure;

FIG. 8 is a perspective view of an embodiment of the adjustable hitch assembly in accordance with the present disclosure; and

FIG. 9 is a perspective view of an embodiment of the adjustable hitch assembly in accordance with the present disclosure.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

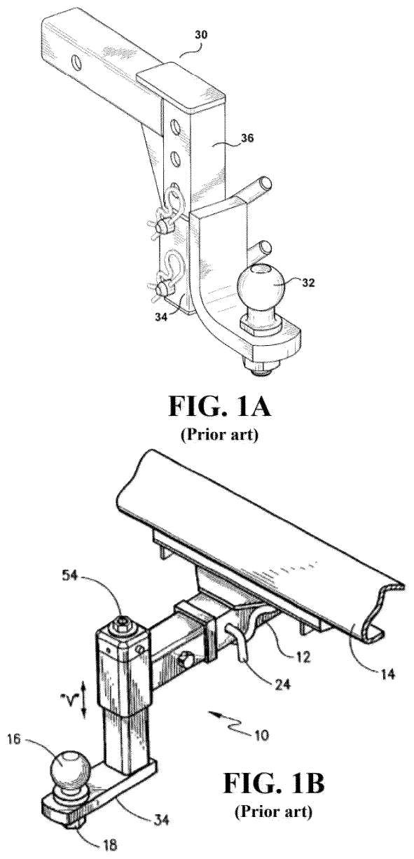

FIG. 1A illustrates a prior art version of a receiver hitch 30. The receiver hitch 30 includes a ball member 32 that is attached to an adjustable member 34. The adjustable member 34 is pinned to a base 36. To adjust the height of the ball member 32, the pins must be removed and the adjustable member 34 may then be aligned with different pinholes. The pins may then be reinserted. This receiver hitch 30 is a shank type assembly.

FIG. 1B illustrates a prior art version of an adjustable hitch assembly 10 that mounts to a hitch receiver 12. A draw bar 34 and hitch ball 16 are adjustable along the direction “v” when the drive nut 54 is rotated to adjust the level of the hitch ball 16.

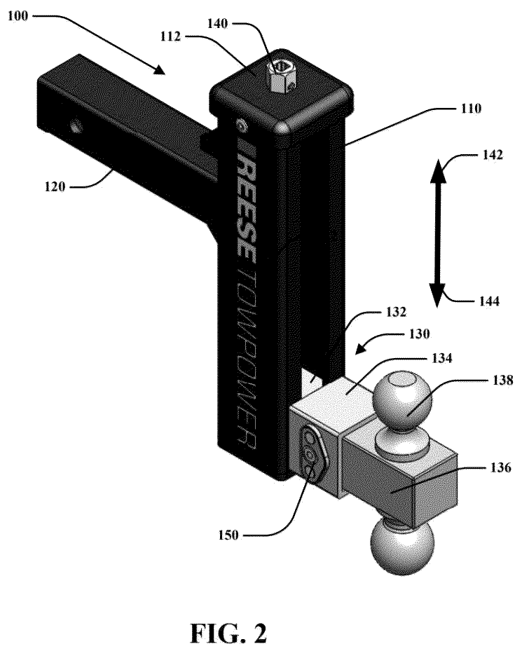

FIG. 2 illustrates an exemplary embodiment of an adjustable hitch assembly 100. Seen in FIG. 2 are the elongated housing 110, end cap 112, hitch bar 120, carriage member 130, base 132, coupling member 134, attachment member 136, hitch ball 138, rotatable drive 140, and locking member 150. The elongated housing 110, which may be attached to a towed vehicle or a towing vehicle, such as by way of a non-limiting example through a hitch bar 120 attached thereto. In this embodiment, the hitch bar 120 may be configured to be operatively inserted into a hitch receiver attached with a vehicle. Alternatively, the housing 110 may be attached to other loads that may require coupling to another load to be towed and this disclosure is not limited to the disclosed embodiments.

The housing 110 may be generally elongated having sides that define an interior region. A carriage member 130 may be positioned within the interior region of the housing 110. The carriage member 130 may include a base 132 and a coupling member 134 wherein the base 132 is positioned within the interior region of the housing 110 and the coupling member 134 is positioned exterior the interior region.

A threaded shaft (not shown) within the housing 110 may include a longitudinal axis that is generally parallel to or coextensive with a longitudinal axis of the housing 110. The threaded shaft may be held inside the housing by a rotatable drive 140 positioned on at least one end of the threaded shaft. An end cap 112 may be positioned along the housing 110 and the rotatable drive 140 may be positioned on the end cap 112. The rotatable drive 140 may be a nut or other fastener configured to mate with a tool or motor to impart rotation.

The carriage member 130 may be mounted to the threaded shaft within the housing 110 such that rotation of the threaded shaft may cause the carriage member 130 to translate relative to the housing 110. The base 132 may include a threaded hole 133 to engage along the threaded shaft. Rotation of the rotatable drive 140 in a first direction may cause the carriage member 130 to translate in a first direction 142 while rotation of the rotatable drive in an opposite second direction may cause the carriage member 130 to translate in a second direction 144. Those skilled in the art will recognize, that the example provided is illustrative purposes and various configurations of the adjustable hitch assembly can be utilized to achieve the same results.

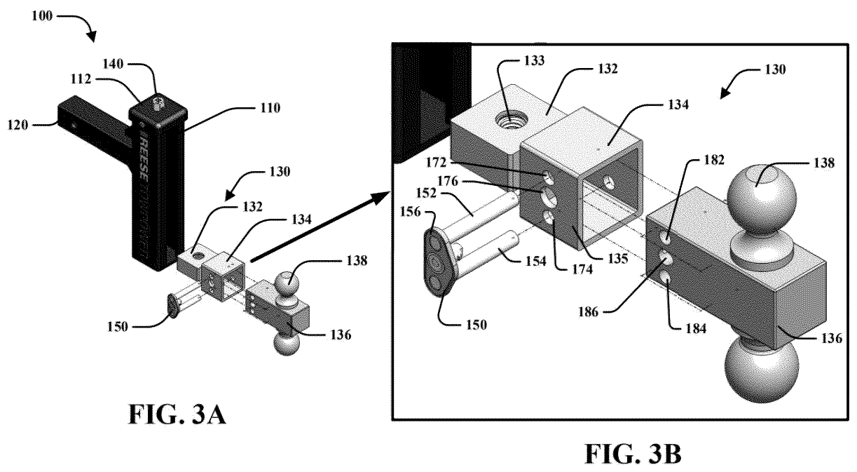

As illustrated by FIGS. 3A and 3B, the coupling member 134 may be selectively coupled to an attachment member 136. In one embodiment, the attachment member 136 may include at least one hitch ball 138. However, as will be discussed, various other hitch related articles are contemplated to be included with or selectively attached to the attachment member 136 herein and this disclosure is not limited to hitch balls. The attachment member 136 may be selectively coupled to the coupling member 134 in a secure manner to allow towing loads and forces to act on the adjustable hitch assembly 100. The coupling member 134 may receive the attachment member 136 therein such that the coupling member 134 and the attachment member 136 may have a plurality of apertures that align with one another when coupled. The coupling member 134 may include a perimeter wall 135 having at least one aperture to engage with a locking member 150. In one embodiment, the perimeter wall 135 includes first aperture 172, a second aperture 174, and a lock aperture 176. Additionally, the attachment member 136 may include at least one aperture to engage with the locking member 150. In one embodiment, the attachment member 136 includes a first aperture 182, a second aperture 184, and a lock aperture 186. However, the apertures of the coupling member 134 and the attachment member 136 may include various shapes, sizes, or amounts as may be used to properly correspond with the locking member 150 with the coupling member 134 and attachment member 136. The respective first and second apertures may extend entirely through the respective members 134, 136 while the respective lock apertures 176, 186 may only extend through a portion of the respective members 134, 136.

The locking member 150 may be utilized to selectively secure and lock the attachment member 136 to the coupling member 134. The locking member 150 may include at least one pin that extends through the apertures of both the coupling member 134 and the attachment member 136.

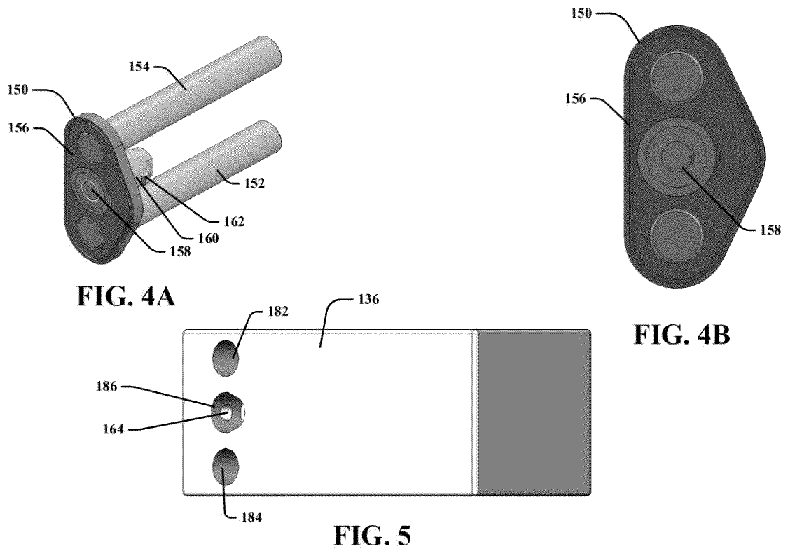

As illustrated by FIGS. 4A and 4B, the locking member 150 may include multiple pins such as first pin 152 and second pin 154. The first pin 152 may be aligned with and extend through the aligned first apertures 172, 182 while the second pin 154 may be aligned with and extend through the aligned second apertures 174, 184. However, the number of pins of the locking member is not limited. The locking member 150 may also include a lock base 156 wherein the pins may be attached to the lock base and may extend from a common side thereof. The pins may be generally parallel to one another as positioned along the lock base 156. A locking mechanism 158 that may also be attached to the lock base 156. In one embodiment, the locking mechanism 158 may be a tubular lock device that corresponds with a cylinder shape key. The locking mechanism 158 may include a keyway and a plug 160 that includes a protrusion 162. The plug 160 and protrusion 162 may be extended through the lock aperture 176 of the coupling member 134 and be received within the lock aperture 186 of the attachment member 136. The protrusion 162 may be toggled against a detent or interior portion 164 of the lock aperture 186 of the attachment member 136 to lock or unlock the locking member 150. See FIG. 5.

The components of the adjustable hitch assembly 100 may be made from a rigid material such as metal, alloy, or polymer (such as steel). The various components may be formed from a generally continuous material. The components sufficiently structurally rigid to support a coupling between a towed vehicle and a towing vehicle and the various forces that may act thereon. The locking mechanism 150 may be of a robust structure to allow towing forces to act on the adjustable hitch assembly 100 while securely maintaining the coupling member 134 to the attachment member 136. This configuration may allow the components to be placed in a secured position that may prevent others from tampering or removing the attachment member 136 relative to the coupling member 134 and allow for these members to be toggled between locked and unlocked configurations. This allows for a user to securely mount various different towing articles to the adjustable hitch assembly 100 such that each article may be lockably secured thereon as well as vertically adjustable along the housing of the assembly.

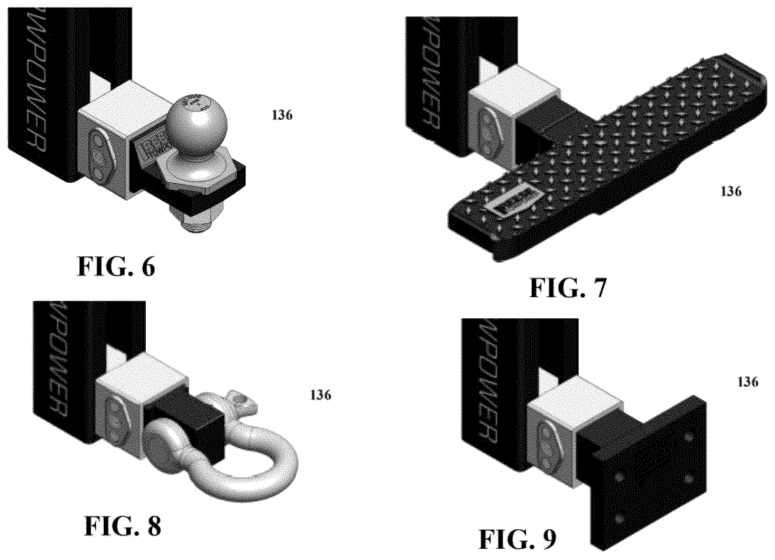

As illustrated by FIGS. 6-9, the adjustable hitch assembly 100 may be configured to attach with various towing accessories. Such as by way of a non-limiting example, the attachment member 136 may be of any appropriate configuration, size and shape to accommodate the various towing accessories. In these embodiments, the towing accessories may be integrated with (such as being attached or monolithically formed with) the attachment member 136. The operation of which is not described for the sake of brevity, but functions at least as disclosed herein for the configuration for the hitch ball.

FIG. 6 illustrates an embodiment of the attachment member 136 having a towing accessory that includes hitch ball with an acircular base. The attachment member 136 including a recessed surface that mates with the acircular base of the hitchball. The hitch ball may include a shank having threads that extends through the attachment member 136 and is fastened with a nut to secure the hitch ball to the attachment member 136.

FIG. 7 illustrates an embodiment of the attachment member 136 having a towing accessory that includes a step with an elongated surface. The step includes a surface that extends generally perpendicularly relative to the attachment member 136 and is sufficient to support a user thereon.

FIG. 8 illustrates an embodiment of the attachment member 136 having a towing accessory that includes a shackle with an attachment pin. The attachment pin extending through the attachment member 136 for pivotal attachment of the shackle thereto.

FIG. 9 illustrates an embodiment of the attachment member 136 having a towing accessory that includes a pintle plate. The pintle plate including a recessed surface that extends outwardly from the adjustable hitch assembly 100 and is adapted to attach to a surface of a load to be towed. In this embodiment, the pintle plate has apertures for attachment to the load with fasteners. However, other attachment configurations are contemplated by this disclosure and this application is not limited as to the type of towing accessory that may be included with the attachment member 136.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

We claim:

1. An adjustable hitch assembly comprising:
an elongated housing having an elongated interior;
a threaded shaft extending within the interior of the housing;
a carriage member including a base, a coupling member and an attachment member, wherein the base is at least partially within the elongated housing and threadably received on said shaft for translation within the housing, the coupling member is attached to the base, the attachment member is selectively secured to the coupling member; and
a locking member to selectively attach the coupling member and the attachment member;
wherein rotation of the threaded shaft imparts translation of the carriage member relative to the elongated housing.

2. The adjustable hitch assembly according to claim 1, wherein said locking member is selectively lockable to prevent or allow said locking member from being removed from the coupling member and the attachment member.

3. The adjustable hitch assembly according to claim 1, wherein said locking member includes at least one pin that extends from a lock base.

4. The adjustable hitch assembly according to claim 3, wherein said locking member includes a first pin and a second pin that extend from a common side of the lock base.

5. The adjustable hitch assembly according to claim 4, wherein the pins are generally parallel to one another as positioned along the lock base.

6. The adjustable hitch assembly according to claim 3 further comprising a locking mechanism attached to the lock base.

7. The adjustable hitch assembly according to claim 6, wherein the locking mechanism is a tubular lock device that corresponds with a cylinder shape key.

8. The adjustable hitch assembly according to claim 6, wherein the locking mechanism includes a keyway and a plug with a protrusion, the plug and protrusion are configured to selectively extended through the coupling member and be received within the attachment member.

9. The adjustably hitch assembly according to claim 8, wherein the protrusion is selectively toggled against an interior portion of the attachment member to lock or unlock the locking member.

10. The adjustable hitch assembly according to claim 1, wherein said attachment member further comprises a towing accessory extending therefrom.

11. The adjustable hitch assembly according to claim 10, wherein the towing accessory includes at least one of a hitch ball, a hitch ball with an acircular base, a step, a shackle, and a pintle plate.

12. An adjustable hitch assembly comprising:
an elongated housing having an elongated interior;
a threaded shaft extending within the interior of the housing;
a carriage member which is at least partially within the elongated housing and threadably received on said threaded shaft;
an attachment member coupled to the carriage member; and
a locking member configured to selectively attach the attachment member with the carriage member.
wherein rotation of the threaded shaft imparts translation of the carriage member relative to the elongated housing.

13. The adjustable hitch assembly according to claim 12, wherein the carriage member carriage member further comprises:
a base;
a coupling member; and
an attachment member;
wherein the base is at least partially within the elongated housing and threadably received on said shaft for translation within the housing, the coupling member is attached to the base, the attachment member is selectively secured to the coupling member.

14. The adjustable hitch assembly according to claim 13, wherein said locking member is selectively lockable to prevent or allow said locking member from being removed from the coupling member and the attachment member.

15. The adjustable hitch assembly according to claim 1, wherein said locking member includes at least one pin that extends from a lock base.

16. The adjustable hitch assembly according to claim 15, wherein said locking member includes a first pin and a second pin that extend from a common side of the lock base.

17. The adjustable hitch assembly according to claim 16, wherein the pins are generally parallel to one another as positioned along the lock base.

18. A method for attaching and adjusting a hitch assembly, comprising:
providing an elongated housing having an elongated interior;
extending a threaded shaft within the interior of the housing;
configuring a carriage member comprising a base, a coupling member, and an attachment member;
positioning the base at least partially within the elongated housing and threadably receiving said base on said shaft for translation within the housing;
attaching the coupling member to the base;
selectively securing the attachment member to the coupling member; and
utilizing a locking member to selectively attach the coupling member and the attachment member;
wherein rotating the threaded shaft imparts translation of the carriage member relative to the elongated housing.
